(19) United States
(12) Patent Application Publication
(10) Pub. No.: US 2016/0259740 A1
(43) Pub. Date: Sep. 8, 2016

(54) INFORMATION PROCESSING SYSTEM, MONITORING METHOD, AND RECORDING MEDIUM

(71) Applicant: FUJITSU LIMITED, Kawasaki-shi (JP)

(72) Inventor: Keiji MIYAZAKI, Kawasaki (JP)

(73) Assignee: FUJITSU LIMITED, Kawasaki-shi (JP)

(21) Appl. No.: 15/049,238

(22) Filed: Feb. 22, 2016

(30) Foreign Application Priority Data
Mar. 6, 2015 (JP) 2015-044248

(51) Int. Cl. G06F 13/24; G06F 13/36

(52) U.S. Cl. CPC G06F 13/24; G06F 13/36

(57) ABSTRACT

An information processing system comprising: an information processing device coupled to a terminal device; and a monitor device coupled to the information processing device, wherein the information processing device includes a first processor configured to process a request from the terminal device, and calculate a frequency of interrupts received by the first processor, and wherein the monitor device includes a memory, and a second processor configured to obtain, from the information processing device, information on the calculated frequency of interrupts, and determine whether or not the frequency of interrupts exceeds a threshold in a particular period based on the obtained information on the frequency of interrupts, and store a result of the determination in the memory.

### CROSS-REFERENCE TO RELATED APPLICATION

This application is based upon and claims the benefit of priority of the prior Japanese Patent Application No. 2015-044248, filed on Mar. 6, 2015, the entire contents of which are incorporated herein by reference.

### FIELD

The embodiments discussed herein are related to an information processing system, a monitoring method, and a recording medium.

### BACKGROUND

Infrastructure as a Service (IaaS) is a model that provides, as a service to users, an infrastructure (for example, hardware resources) for building and running a computer system via a network, such as the Internet. A computer system is built on the infrastructure using IaaS, and the user uses applications executed on a virtual machine running on the computer system.

In order to avoid degradation in the performance of applications in response to requests from user terminals, the administrator of IaaS monitors the state of the computer system and searches for a phenomenon that is likely to cause a degradation in response performance. Such a phenomenon is easily found in some cases and is not easily found in other cases. For example, a phenomenon such as an increase in the usage rate of a central processing unit (CPU), which is an arithmetic processing unit, or a decrease in the speed of input or output (I/O) to or from a storage device, which is a kind of an input/output device, may be easily found by the administrator. However, although such a phenomenon has not occurred and the state of the computer system seems normal, the response performance of a virtual machine is degraded in some cases. A fault that occurs in such a manner is referred to as a silent fault.

In related art techniques for monitoring the performance of a computer system, no attention is paid to the silent fault issue and this issue is not considered to be problematic.

Examples of documents of the related art techniques include Japanese Laid-open Patent Publication No. 2011-123857 and Japanese Laid-open Patent Publication No. 2-109148.

### SUMMARY

According to an aspect of the invention, an information processing system comprising: an information processing device coupled to a terminal device; and a monitor device coupled to the information processing device, wherein the information processing device includes a first processor configured to process a request from the terminal device, and calculate a frequency of interrupts received by the first processor, and wherein the monitor device includes a memory, and a second processor configured to obtain, from the information processing device, information on the calculated frequency of interrupts, and determine whether or not the frequency of interrupts exceeds a threshold in a particular period based on the obtained information on the frequency of interrupts, and store a result of the determination in the memory.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 depicts the relationship between the response performance of an application and the frequency of external interrupts;

FIG. 2 illustrates a graph depicting variations in the frequency of external interrupts that occur during input and output of data;

FIG. 3 illustrates an outline of a system in the present embodiments;

FIG. 4 is a configuration diagram of a physical server;

FIG. 5 is a functional block diagram of an IaaS management server;

FIG. 6 depicts an example of data stored in a performance data storage unit;

FIG. 7 depicts an example of data stored in the performance data storage unit;

FIG. 8 depicts an example of data stored in a threshold storage unit;

FIG. 9 depicts an example of data stored in an analysis result storage unit in a first embodiment;

FIG. 10 illustrates a processing flow of a process executed by an analysis unit;

FIG. 11 depicts a state of the performance data storage unit and a state of the threshold storage unit;

FIG. 12 depicts changes in a state of the analysis result storage unit;

FIG. 13 depicts a state of the performance data storage unit and a state of the threshold storage unit;

FIG. 14 depicts changes in a state of the analysis result storage unit;

FIG. 15 is a graph for explaining changes in threshold;

FIG. 16 illustrates a processing flow of a process executed by the analysis unit in a second embodiment;

FIG. 17 is a diagram for explaining the relationship between the interrupt and the processing delay;

FIG. 18 is a diagram for explaining interrupts within a physical server where VMs run; and

FIG. 19 is a functional block diagram of a computer.

### DESCRIPTION OF EMBODIMENTS

According to one aspect of embodiments disclosed herein, there is provided a technique for monitoring the performance in response to requests from a terminal device.

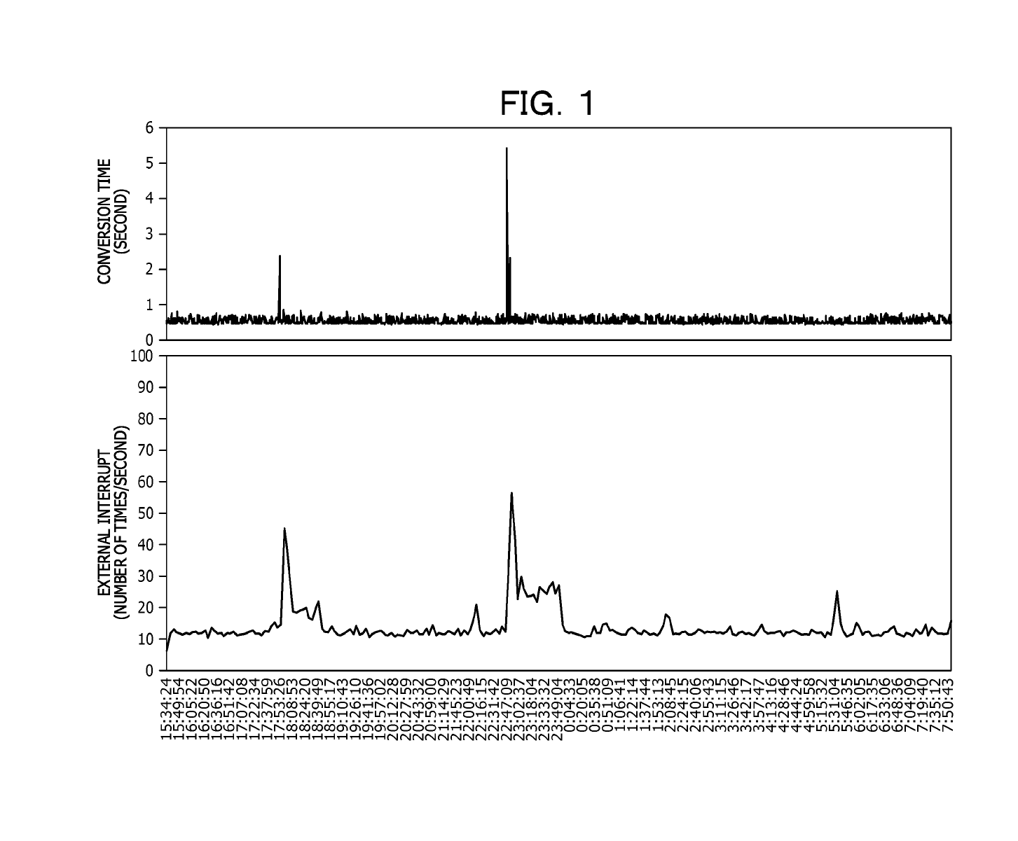

The response performance of an application is affected by external interrupts received by a CPU. FIG. 1 depicts the relationship between the response performance of an application and the external interrupt. The upper graph in FIG. 1 is a graph depicting variations in a period of time acquired from after an application for supporting the input of Japanese characters receives an instruction to convert given kana characters until the application completes the conversion (in units of seconds, hereinafter referred to as a conversion time), where the vertical axis represents the conversion time and the horizontal axis represents time. The lower graph in FIG. 1 is a graph depicting variations in the frequency of external interrupts (the number of times/second) received by a CPU, where the vertical axis represents the frequency of external interrupts and the horizontal axis represents time. The external interrupts and internal interrupts are explained later.

As illustrated in FIG. 1, there is a correlation between the conversion time and the frequency of external interrupts. Specifically, the conversion time is long when the frequency of external interrupts is high, and the conversion time is short when the frequency of external interrupts is low. However, if the frequency of external interrupts is smaller than about 35 (the number of times/second), a remarkable peak does not appear in the conversion time. Accordingly, the performance degradation is considered to occur when the frequency of external interrupts exceeds a predetermined threshold.

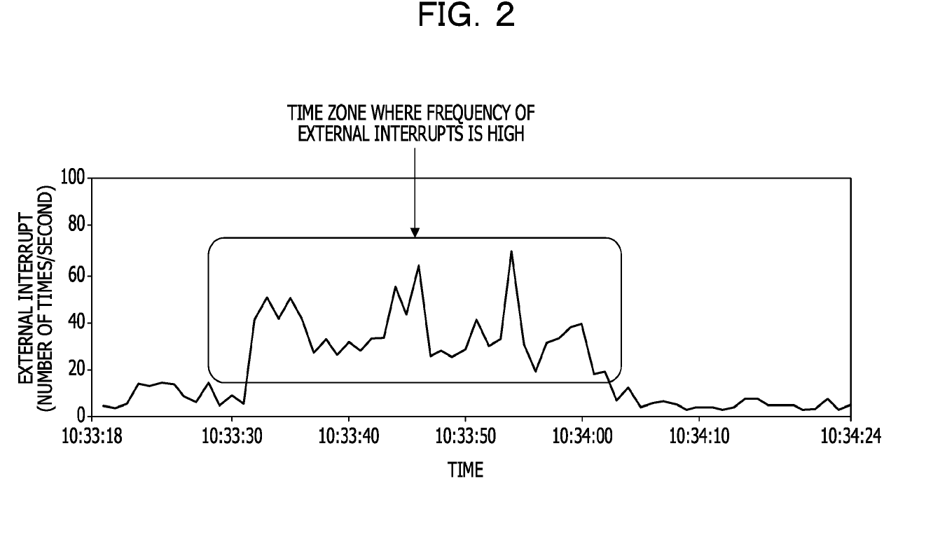

However, when the frequency of external interrupts continuously exceeds a threshold, there are some cases where, even if performance degradation occurs, the performance is not degraded to a large extent, and there are also some cases where, even if performance degradation occurs, the degradation is not continuous. FIG. 2 illustrates a graph depicting variations in the frequency of external interrupts that occur during input and output of data performed usually. In FIG. 2, the vertical axis represents the frequency of external interrupts and the horizontal axis represents time. During input and output of data, a remarkable peak does not necessarily appear, and the state where the frequency of external interrupts is relatively high continues for a certain period of time. However, in such a case, performance degradation that occurs in the case where the frequency of external interrupts becomes instantaneously high does not occur.

In consideration of the points mentioned above, in particular, a phenomenon in which the frequency of external interrupts instantaneously becomes high is considered to cause degradation in the performance of a particular application. To address this, in the present embodiments, the response performance of an application is monitored by a method described below.

### First Embodiment

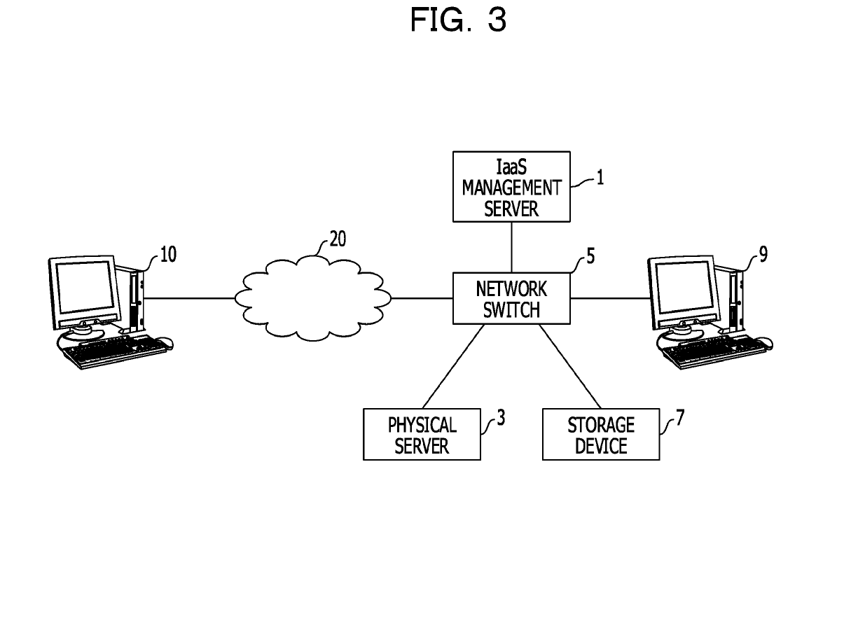

FIG. 3 illustrates an outline of a system in the present embodiment. For example, a user terminal 10 and a network switch 5 are coupled to a network 20, which is, for example, the Internet. A physical server 3 and a storage device 7 that provide the infrastructure of IaaS, an IaaS management server 1 that manages the physical server 3 and the storage device 7, and an IaaS administrator terminal 9 operated by the administrator of IaaS are coupled to the network switch 5.

The user terminal 10 transmits a processing request to the physical server 3 in response to an input operation of the user. In the physical server 3, one or a plurality of virtual machines (VM) are run and each VM executes an application. A VM assigned to the user who operates the user terminal 10, upon receipt of a processing request from the user terminal 10, performs processing in accordance with the processing request and transmits a response including a processing result to the user terminal 10. The storage device 7 is, for example, a hard disk drive (HDD). Note that the storage device 7 may be included in a physical server having a storage management function.

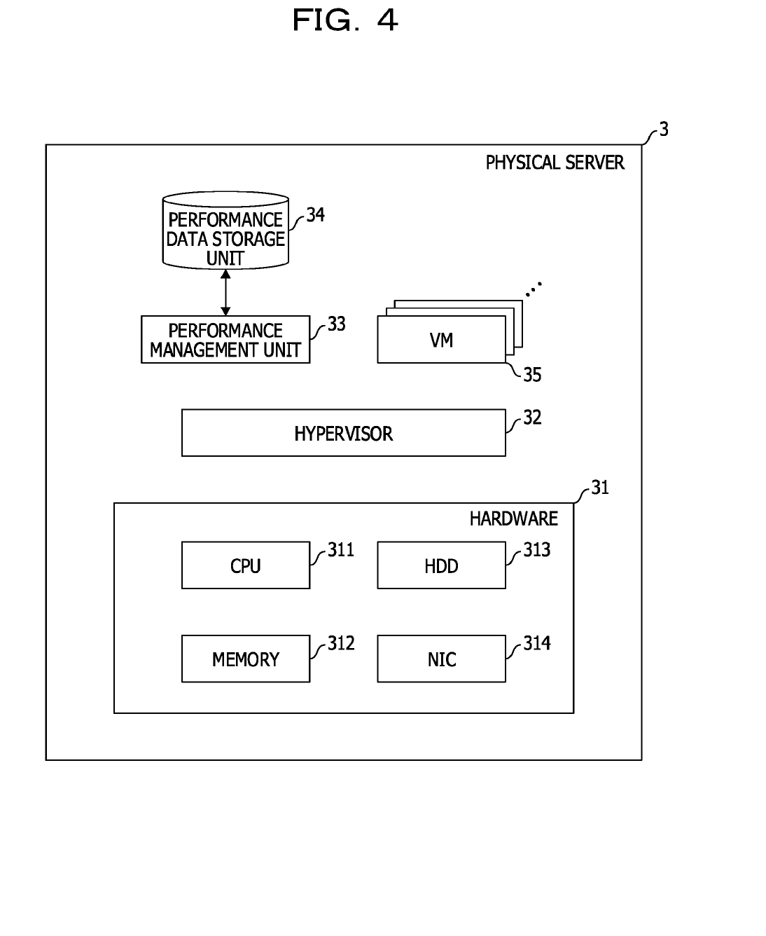

FIG. 4 illustrates a configuration diagram of the physical server 3. The physical server 3 includes hardware 31, a hypervisor 32 that runs on the hardware 31, a performance management unit 33 that operates on the hypervisor 32, one or a plurality of VMs 35, and a performance data storage unit 34. The hardware 31 includes a CPU 311, a memory 312, an HDD 313, and a network interface card (NIC) 314. The hardware 31 may include other hardware. The hypervisor 32 is virtualization software for creating the VMs 35. The hypervisor 32, the performance management unit 33, and the VMs 35 are implemented when the CPU 311 executes a program loaded in the memory 312. The VM 35 performs processing in accordance with a request from the user. The performance management unit 33 computes data on the performance (the frequency of external interrupts in the present embodiment) regularly (for example, every one minute) for each VM 35, stores the data in the performance data storage unit 34, and transmits the data to the IaaS management server 1. The performance data storage unit 34 is provided, for example, in the HDD 313.

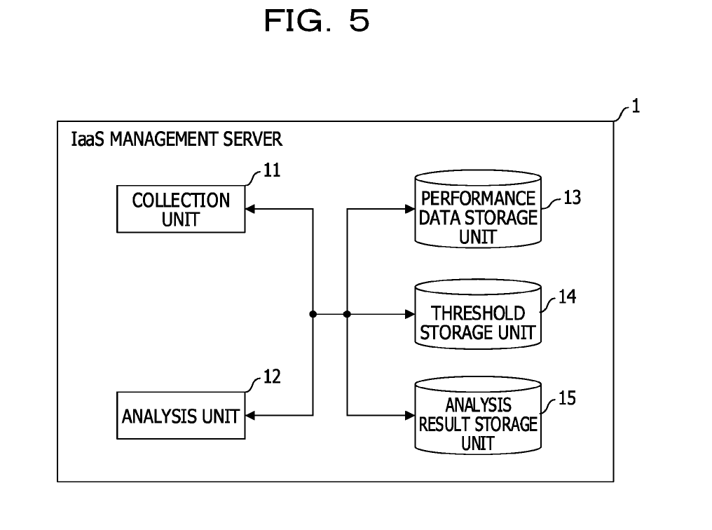

FIG. 5 illustrates a functional block diagram of the IaaS management server 1. The IaaS management server 1 includes a collection unit 11, an analysis unit 12, a performance data storage unit 13, a threshold storage unit 14, and an analysis result storage unit 15.

The collection unit 11 receives data on the performance, for example, regularly from the physical server 3 and stores the data in the performance data storage unit 13. The analysis unit 12 performs processing based on the data stored in the performance data storage unit 13 and the data stored in the threshold storage unit 14 and stores a processing result in the analysis result storage unit 15.

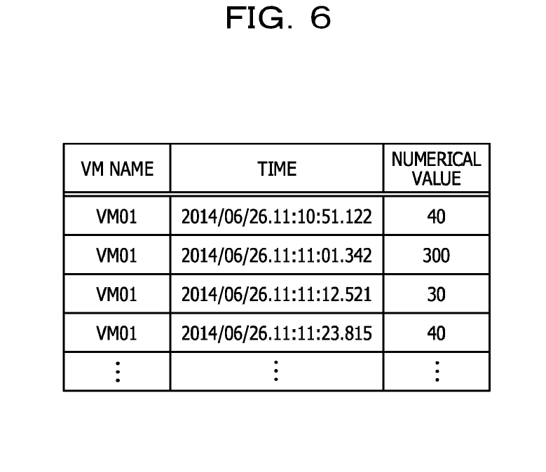

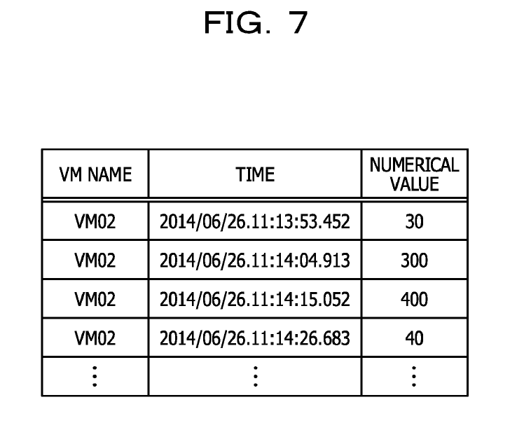

FIG. 6 depicts an example of data stored in the performance data storage unit 13 of the IaaS management server 1. In the example of FIG. 6, a VM name, a point in time at which the frequency of external interrupts is computed, and a numerical value representing the frequency of external interrupts (the number of times/second) are stored. Note that although data on VM01 is depicted in FIG. 6, data is stored for each VM 35 in the performance data storage unit 13 and thus, for example, as depicted in FIG. 7, data on a VM (here, VM02) other than VM01 is also stored. Note that data stored in the performance data storage unit 34 of the physical server 3 is the same as data stored in the performance data storage unit 13 of the IaaS management server

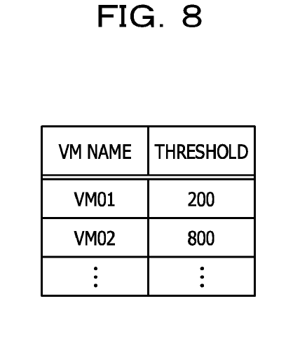

FIG. 8 depicts an example of data stored in the threshold storage unit 14. In the example of FIG. 8, a VM name and a threshold are stored.

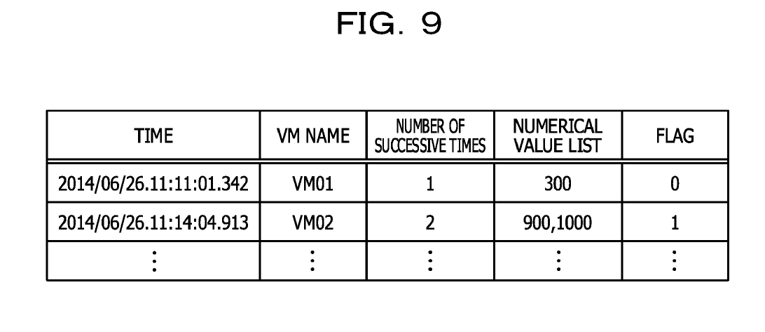

FIG. 9 depicts an example of data stored in the analysis result storage unit 15. In the example of FIG. 9, a point in time at which the frequency of external interrupts is computed, a VM name, the number of successive times, a numerical value list, and a flag are stored. The number of successive times represents the number of successive times the case where the frequency of interrupts exceeds a threshold occurs. In the column of the numerical value list, the frequency of interrupts that has exceeded a threshold is stored. A flag “1” indicates that the state where the frequency of interrupts exceeds a threshold continues, and a flag “0” indicates that the state where the frequency of interrupts exceeds the threshold does not continue.

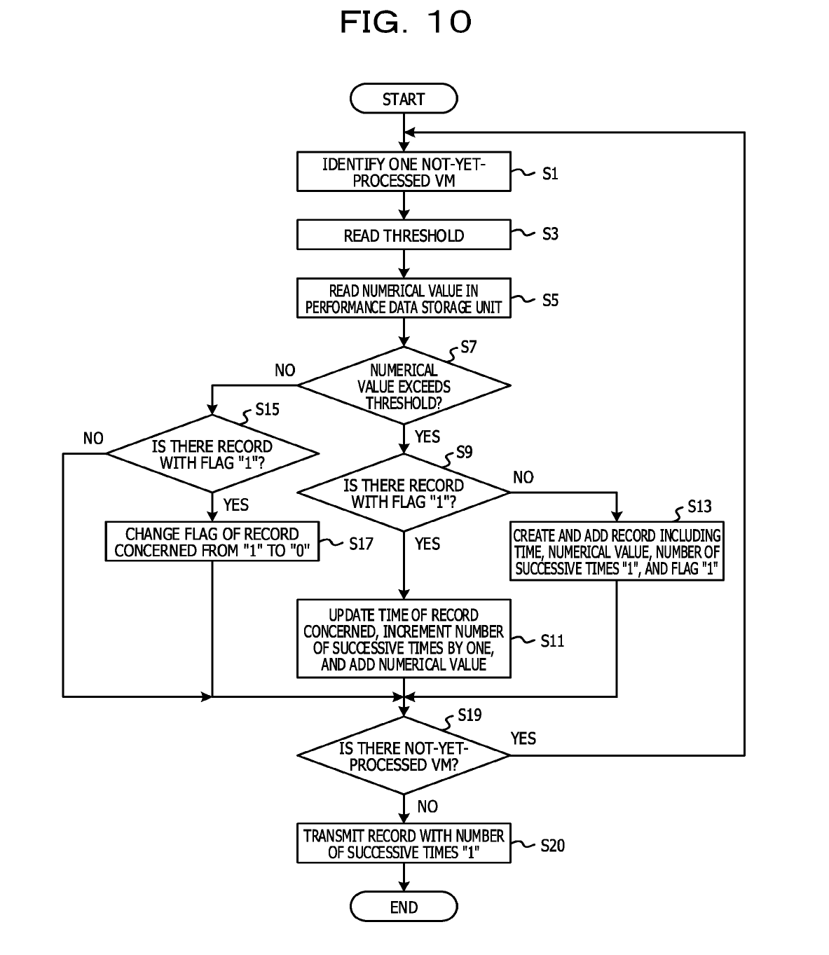

Next, with reference to FIG. 10 to FIG. 14, a process executed by the IaaS management server 1 in a first embodiment will be described. This process is executed regularly (for example, every one minute).

First, the analysis unit 12 identifies one not-yet-processed VM 35 (S1 in FIG. 10) and reads a threshold corresponding to the VM name of the identified VM 35 from the threshold storage unit 14 (S3).

The analysis unit 12 reads the newest numerical value (that is, a numerical value at the latest point in time) among numerical values stored in association with the VM name of the not-yet-processed VM 35 in the performance data storage unit 13 (S5).

The analysis unit 12 determines whether or not the numerical value read in S5 is larger than the threshold read in S3 (S7). If the numerical value read in S5 is larger than the threshold read in S3 (Yes route in S7), the analysis unit 12 determines whether or not there is a record with the flag “1” in records for the not-yet-processed VM 35 stored in the analysis result storage unit 15 (S9).

If there is a record with the flag “1” in records for the not-yet-processed VM 35 (Yes route in S9), the analysis unit 12 updates the point in time of the record concerned with a point in time corresponding to the numerical value read in S5 (that is, a point in time corresponding to the frequency computed last). The analysis unit 12 increments the number of successive times in the record concerned by one and adds the numerical value read in S5 to the numerical value list in the record concerned (S11). Then, the analysis unit 12 proceeds to the process in S19.

If there is no record with the flag “1” in records for the not-yet-processed VM 35 (No route in S9), the analysis unit 12 creates a record including a point in time corresponding to the numerical value read in S5, the numerical value read in S5, the number of successive times “1”, and the flag “1” and adds the created record to the analysis result storage unit 15 (S13). Then, the analysis unit 12 proceeds to the process in S19.

On the other hand, if the numerical value read in S5 is smaller than or equal to the threshold read in S3 (No route in S7), the analysis unit 12 determines whether or not there is a record with the flag “1” in records for the not-yet-processed VM 35 stored in the analysis result storage unit 15 (S15).

If there is a record with the flag “1” in records for the not-yet-processed VM 35 (Yes route in S15), the analysis unit 12 changes the flag of the record concerned from “1” to “0” (S17). Then, the analysis unit 12 proceeds to the process in S19.

On the other hand, if there is no record with the flag “1” in records for the not-yet-processed VM 35 (No route in S15), the analysis unit 12 proceeds to the process in S19.

The analysis unit 12 determines whether or not there is a not-yet-processed VM 35 (S19). If there is a not-yet-processed VM 35 (Yes route in S19), the analysis unit 12 returns to the process in S1 in order to execute the process for the next VM 35. On the other hand, if there is no not-yet-processed VM 35 (No route in S19), the analysis unit 12 determines whether or not there is a record with the number of successive times “1” among records stored in the analysis result storage unit 15. If there is a record with the number of successive times “1”, the analysis unit 12 transmits information including the record with the number of successive times “1” to the IaaS administrator terminal 9 (S20). Then, the process is completed. Note that information including the record with the number of successive times “1”, after being changed into a form specified by the user, may be transmitted to the user terminal 10.

Note that, when the IaaS administrator terminal 9 receives information transmitted in S20, the administrator who operates the IaaS administrator terminal 9 causes the information to be displayed on a display device or the like. The administrator, upon checking the content of the information, takes measures for suppressing degradation in response performance by operating the IaaS administrator terminal 9. For example, the administrator performs a configuration change (for example, increasing the number of parallel HDDs) of the storage device 7 in which a disk image of the VM 35 with degraded response performance is saved. For example, the administrator also moves a disk image of the VM 35 with degraded response performance to another storage device with small load.

Executing the process described above results in that records for points in time at which a threshold is exceeded are stored in the analysis result storage unit 15. Since the number of successive times is included in each record, it becomes possible to extract a record based on the number of successive times and to notify the user terminal 10 of the record. This allows the user who operates the user terminal 10 to take measures for suppressing degradation in response performance.

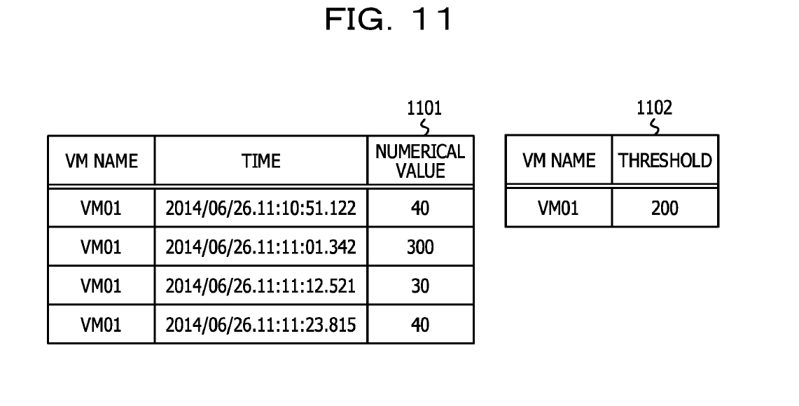

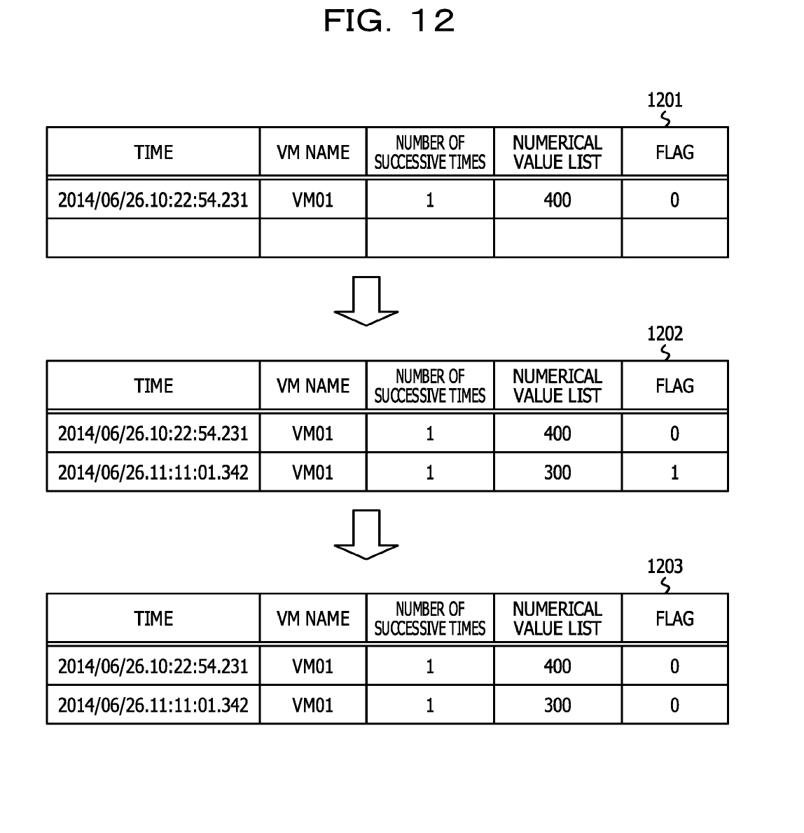

Here, with reference to FIG. 11 to FIG. 14, changes in the state of the analysis result storage unit 15 will be described. In a first example, it is assumed that the state of the performance data storage unit 13 and the state of the threshold storage unit 14 are states as depicted in FIG. 11. In FIG. 11, a left-side table 1101 represents a state of the performance data storage unit 13, and a right-side table 1102 represents a state of the threshold storage unit 14. A table 1201 in FIG. 12 represents an initial state of the analysis result storage unit 15.

The record in the first row of the table 1101 has a numerical value smaller than the threshold and thus is not registered in the analysis result storage unit 15. Consequently, the state of the analysis result storage unit 15 remains the same as that of the table 1201 in FIG. 12.

The record in the second row of the table 1101 has a numerical value larger than the threshold and thus is registered in the analysis result storage unit 15. However, the flag of a record already registered in the table 1201 in FIG. 12 is “0”. A new record is thus created, and the result of the analysis result storage unit 15 becomes a state as depicted in a table 1202 in FIG. 12. The flag of the newly created record is “1”.

The record in the third row of the table 1101 has a numerical value smaller than the threshold and thus is not registered in the analysis result storage unit 15. Here, the flag of the record in the second row in the analysis result storage unit 15 is changed from “1” to “0”, and the state of the analysis result storage unit 15 becomes a state as depicted in a table 1203 in FIG. 12.

The record in the fourth row of the table 1101 has a numerical value smaller than the threshold and thus is not registered in the analysis result storage unit 15. Consequently, the state of the analysis result storage unit 15 remains the same as that of the table 1203 in FIG. 12.

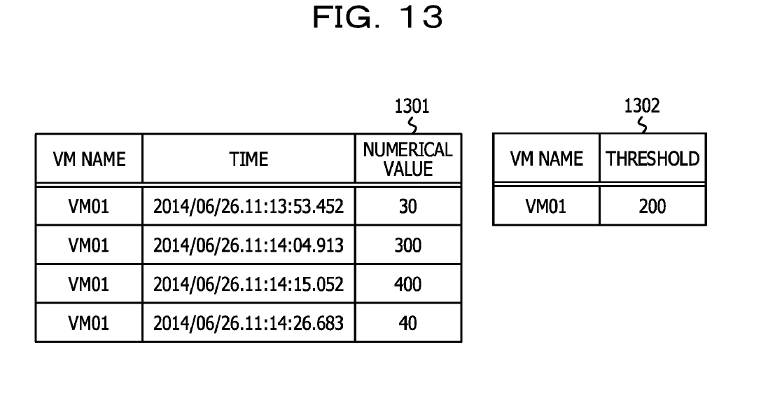

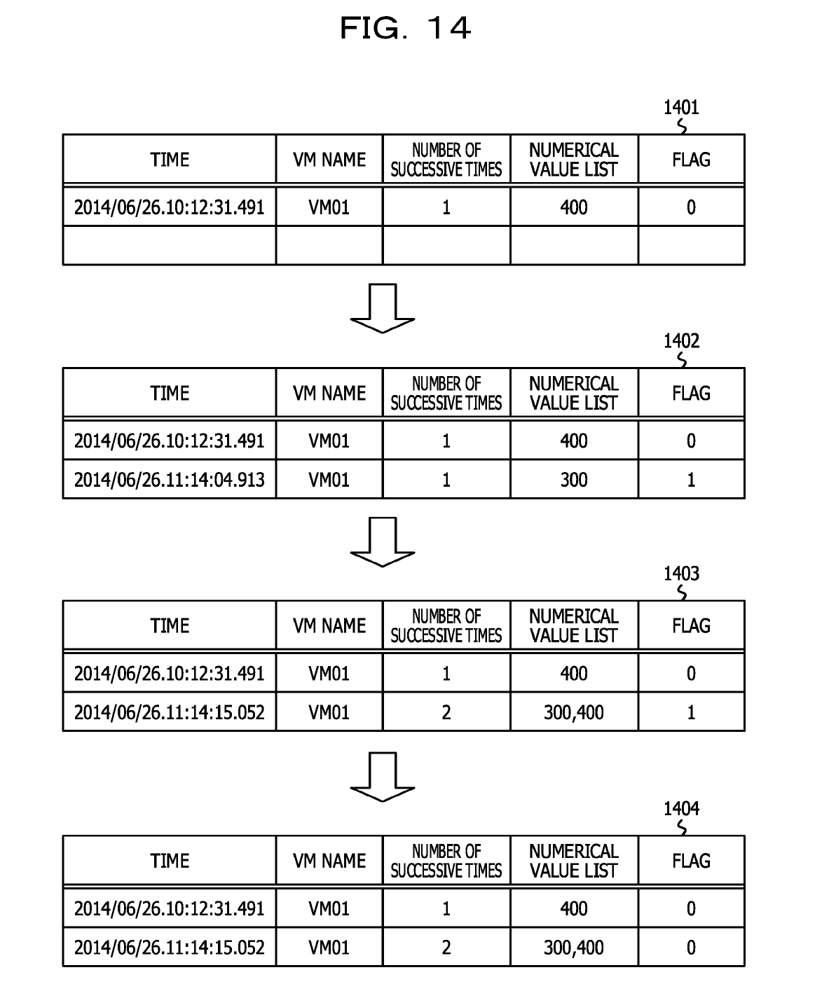

In a second example, it is assumed that the state of the performance data storage unit 13 and the state of the threshold storage unit 14 are states as depicted in FIG. 13. In FIG. 13, a left-side table 1301 represents a state of the performance data storage unit 13, and a right-side table 1302 represents a state of the threshold storage unit 14. A table 1401 in FIG. 14 represents an initial state of the analysis result storage unit 15.

The record in the first row of the table 1301 has a numerical value smaller than the threshold and thus is not registered in the analysis result storage unit 15. Consequently, the state of the analysis result storage unit 15 remains the same as that of the table 1401 in FIG. 14.

The record in the second row of the table 1301 has a numerical value larger than the threshold and thus is registered in the analysis result storage unit 15. However, the flag of a record already registered in the table 1401 in FIG. 14 is “0”. A new record is thus created, and the state of the analysis result storage unit 15 becomes a state as depicted in a table 1402 in FIG. 14. The flag of the newly created record is “1”.

The record in the third row of the table 1301 has a numerical value larger than the threshold and thus is registered in the analysis result storage unit 15. Here, the flag of the record in the second row in the analysis result storage unit 15 is “1”, and thus the numerical value of the record in the third row of the table 1301 is added to a numerical value list of the record in the second row in the analysis result storage unit 15. Additionally, the point in time of the record in the second row in the analysis result storage unit 15 is updated with the point in time of the record in the third row of the table 1301. Consequently, the state of the analysis result storage unit 15 becomes a state as depicted in a table 1403 in FIG. 14.

The record in the fourth row of the table 1301 has a numerical value smaller than the threshold and thus is not registered in the analysis result storage unit 15. Here, the flag of the record in the second row in the analysis result storage unit 15 is changed from “1” to “0”, and the state of the analysis result storage unit 15 becomes a state as depicted in a table 1404 in FIG. 14.

### Second Embodiment

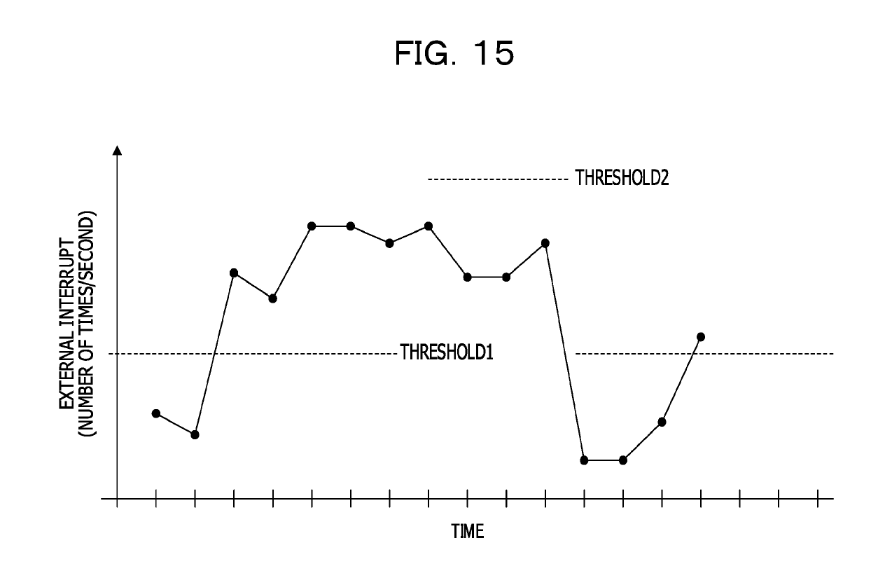

As described above, when the frequency of external interrupts continuously exceeds a threshold, there are some cases where, even if performance degradation occurs, the performance is not degraded to a large extent, and there are also some cases where, even if performance degradation occurs, the degradation is not continuous. However, for example, as depicted in FIG. 15, when, in a situation where the frequency of external interrupts continuously exceeds a threshold, the frequency of external interrupts further increases instantaneously, degradation in response performance occurs in some cases. In FIG. 15, the vertical axis represents the frequency of external interrupts (the number of times/second) and the horizontal axis represents time. In such a case, if the same threshold continues to be used, it is not possible to detect degradation in response performance.

To address this, in a second embodiment, a method of reducing oversight of degradation in response performance by dynamically changing the threshold (in the example in FIG. 15, changing between a threshold 1 and a threshold 2) will be described.

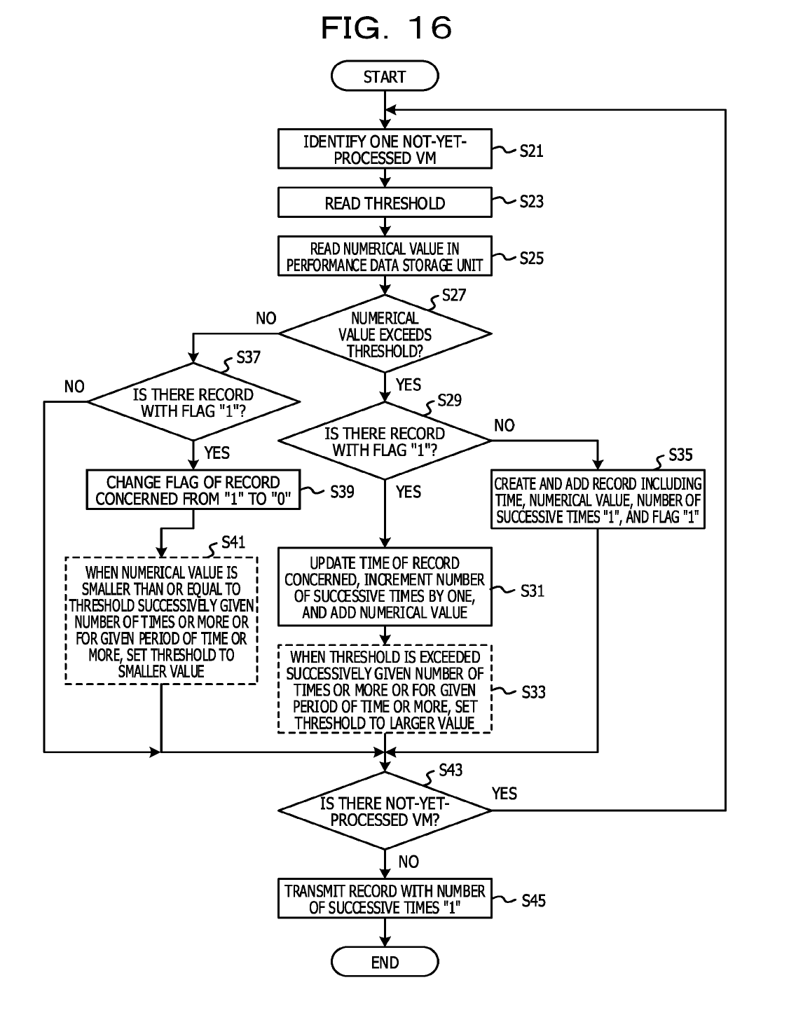

With reference to FIG. 16, a process executed by the IaaS management server 1 in the second embodiment will be described. This process is executed regularly (for example, every one minute).

First, the analysis unit 12 identifies one not-yet-processed VM 35 (S21 in FIG. 16) and reads a threshold corresponding to the VM name of the identified VM 35 from the threshold storage unit 14 (S23).

The analysis unit 12 reads the newest numerical value (that is, a numerical value at the latest point in time) among numerical values stored in association with the VM name of the not-yet-processed VM 35 in the performance data storage unit 13 (S25).

The analysis unit 12 determines whether or not the numerical value read in S25 is larger than the threshold read in S23 (S27). If the numerical value read in S25 is larger than the threshold read in S23 (Yes route in S27), the analysis unit 12 determines whether or not there is a record with the flag “1” in records for the not-yet-processed VM 35 stored in the analysis result storage unit 15 (S29).

If there is a record with the flag “1” in records for the not-yet-processed VM 35 (Yes route in S29), the analysis unit 12 updates the point in time of the record concerned with a point in time corresponding to the numerical value read in S25 (that is, a point in time corresponding to the frequency computed last). Then, the analysis unit 12 increments the number of successive times in the record concerned by one and adds the numerical value read in S25 to the numerical value list in the record concerned (S31).

When the numerical value exceeds the threshold successively a given number of times or more, or for a given period of time or more, the analysis unit 12 sets the threshold associated with the VM name of the not-yet-processed VM 35, which is stored in the threshold storage unit 14, to a larger value (S33). Then, the analysis unit 12 proceeds to the process in S43. Note that the setting of the threshold in S33 is not necessarily performed, and thus, in FIG. 16, the block of S33 is indicated by a broken line. The analysis unit 12 performs the process of S33 by, for example, saving a determination result in S27 and a point in time corresponding to the numerical value read in S25 in a storage device (for example, main memory).

If there is no record with the flag “1” in records for the not-yet-processed VM 35 (No route in S29), the analysis unit 12 creates a record including a point in time corresponding to the numerical value read in S25, the numerical value read in S25, the number of successive times “1”, and the flag “1” and adds the created record to the analysis result storage unit 15 (S35). Then, the analysis unit 12 proceeds to the process in S43.

On the other hand, if the numerical value read in S25 is smaller or equal to the threshold read in S23 (No route in S27), the analysis unit 12 determines whether or not there is a record with the flag “1” in records for the not-yet-processed VM 35 stored in the analysis result storage unit 15 (S37).

If there is a record with the flag “1” in records for the not-yet-processed VM 35 (Yes route in S37), the analysis unit 12 changes the flag of the record concerned from “1” to “0” (S39).

When the numerical value is smaller than or equal to the threshold successively a given number of times or more, or for a given period of time or more, the analysis unit 12 sets the threshold associated with the VM name of the not-yet-processed VM 35, which is stored in the threshold storage unit 14, to a smaller value (S41). Then, the analysis unit 12 proceeds to the process in S43. Similarly to the process in S33, the analysis unit 12 performs the process in S41 by saving a determination result in S27 and a point in time corresponding to the numerical value read in S25 in a storage device (for example, main memory).

On the other hand, if there is no record with the flag “1” in records for the not-yet-processed VM 35 (No route in S37), the analysis unit 12 proceeds to the process in S43.

The analysis unit 12 determines whether or not there is a not-yet-processed VM 35 (S43). If there is a not-yet-processed VM 35 (Yes route in S43), the analysis unit 12 returns to the process in S21 in order to execute the process for the next VM 35. On the other hand, if there is no not-yet-processed VM 35 (No route in S43), the analysis unit 12 determines whether or not there is a record with the number of successive times “1” among records stored in the analysis result storage unit 15. If there is a record with the number of successive times “1”, the analysis unit 12 transmits information including the record with the number of successive times “1” to the IaaS administrator terminal 9 (S45). Then, the process is completed.

Executing the process as described above makes it possible to reduce oversight of performance degradation to improve the detection accuracy.

Although one embodiment of the present disclosure has been described above, the present disclosure is not limited to this. For example, the functional block configuration of the IaaS management server 1 described above does not match the actual program module configuration in some cases.

The configuration of each table described above is an example and each table does not have to have a configuration as described above. Furthermore, in the process flows, the processing orders may be changed unless processing results are not changed. Furthermore, the processing may be performed in parallel.

The example in which the IaaS management server 1 and the physical server 3 are separately provided has been described, the IaaS management server 1 and the physical server 3 may be integrated together. In this case, one VM 35 in the physical server 3 may act as the IaaS management server 1.

Additionally, although, in S20 and S45, information including a record with the number of successive times “1” is transmitted, there is a possibility that performance degradation occurs even if the number of successive times is not “1”. Therefore, records with the numbers of successive times other than the number of successive times “1” may be included in the information.

Next, interrupts will be described.

Examples of an interrupt include an internal interrupt that occurs from a program being run by a processor and an external interrupt that occurs from a factor other than the program being run by the processor. Factors that cause external interrupts to occur are, for example, an input and output device such as a key board or a mouse, an external storage device such as a disk device, and communication with another device via a network.

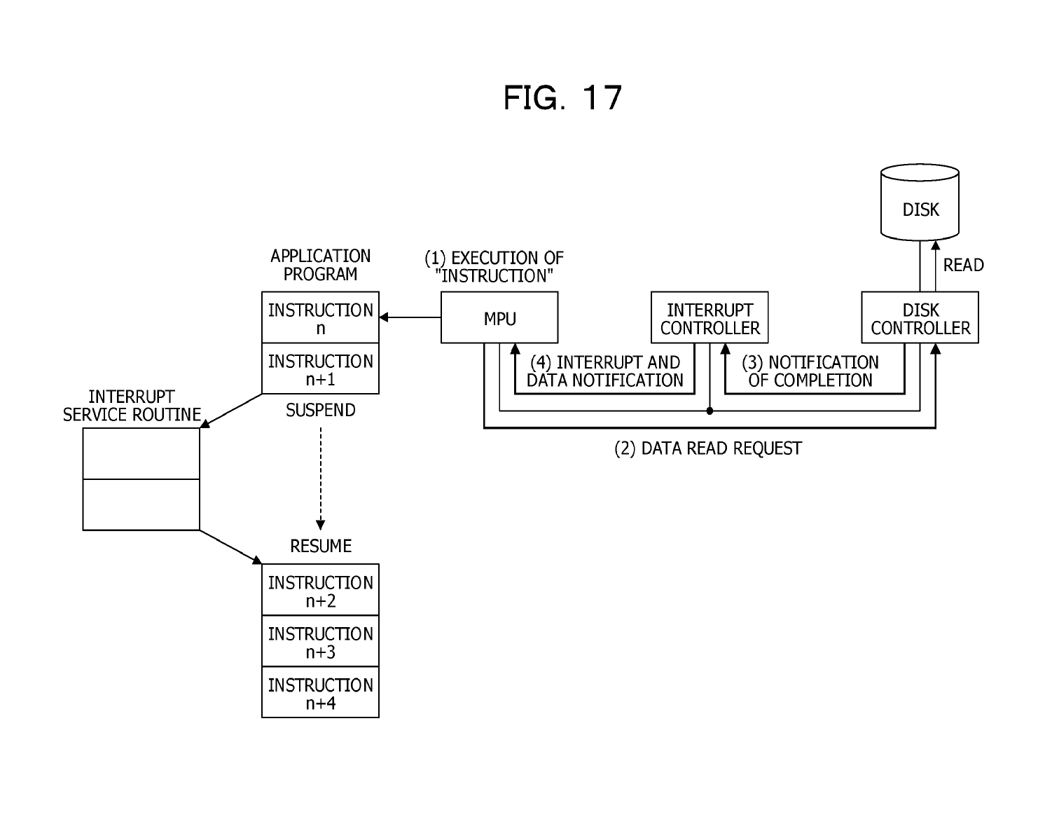

With reference to FIG. 17, the relationship between the interrupt and the processing delay will be described. It is assumed that a micro-processing unit (MPU) outputs, to a disk controller, for example, a data read request to read data from a disk. The factor for outputting a data read request is, in some cases, an application program being run by the MPU and, in other cases, is a program other than the application program or an input and output device or the like.

The disk controller reads data from a disk in accordance with the data read request and notifies an interrupt controller that the data reading is complete. Then, the interrupt controller outputs an interrupt to the MPU and notifies the MPU of information on the data reading.

The MPU, upon detecting the occurrence of an interrupt, suspends the running of an application program and starts to run an interrupt service routine (also called an interrupt handler). In the example in FIG. 17, the running of the application program is suspended after execution of an instruction n+1 is completed. Then, upon completion of the running of the interrupt service routine, the MPU resumes the running of the application program from an instruction n+2.

In such a manner, the running of the application program is delayed by running of the interrupt service routine. Therefore, if a large number of interrupts caused by factors as mentioned above occur, the running of the application program will be significantly delayed.

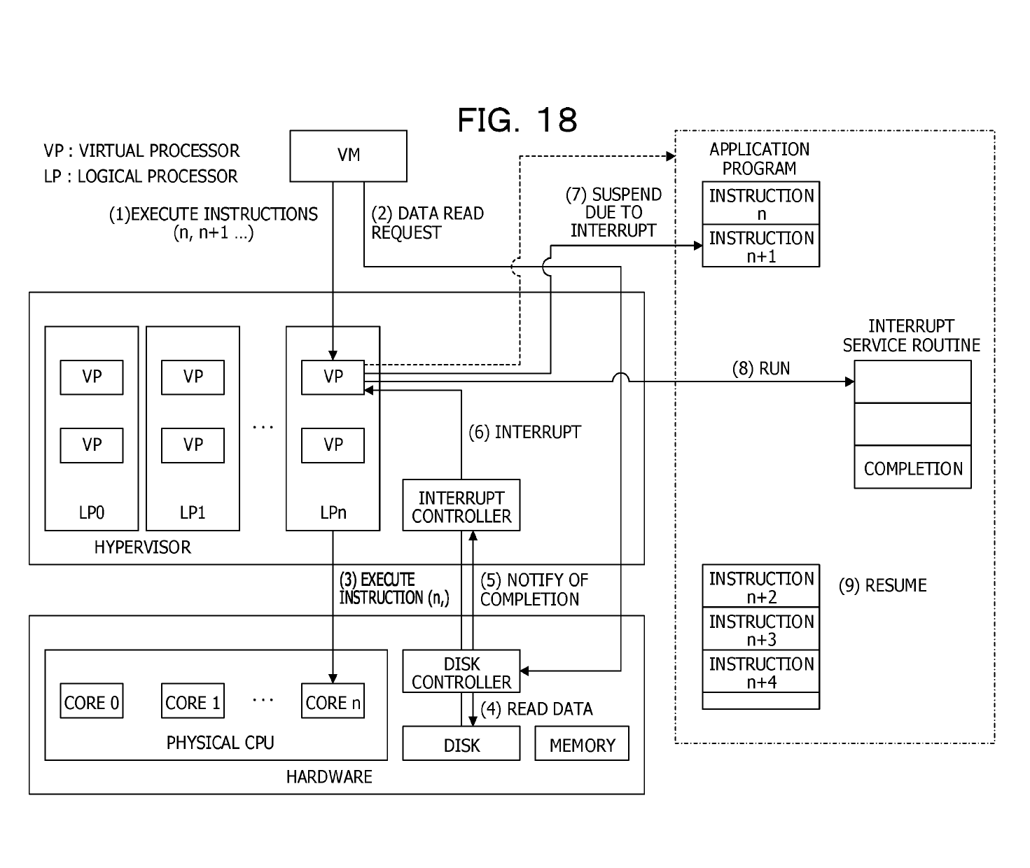

Next, with reference to FIG. 18, interrupts within a physical server where VMs run will be described. In FIG. 18, VP stands for a virtual processor and LP stands for a logical processor.

Hardware includes a physical CPU, a disk controller, a disk such as an HDD, and a memory. The physical CPU includes cores 0 to n. A hypervisor, which runs on the hardware, includes an LP0 corresponding to the core 0, an LP1 corresponding to the core 1, . . . , an LPn corresponding to the core n, and an interrupt controller. A VM runs on the hypervisor. Each LP includes one or a plurality of VPs.

First, the instruction n and the instruction n+1 in the application program are executed. Here, from the viewpoint of the VM, it seems that the LPn executes the application program; however, in practice, the core n in the physical CPU executes the application program.

Here, it is assumed that, during execution of the instruction n and the instruction n+1, a data read request is output to the disk controller. The disk controller reads data from the disk in accordance with the data read request and notifies the interrupt controller of the completion of the data reading. Then, the interrupt controller outputs an interrupt to the LPn and notifies the LPn of information on the data reading.

The LPn, upon detection of the occurrence of an interrupt, suspends the running of the application program and starts to run an interrupt service routine. In the example in FIG. 18, the running of the application program is suspended after execution of the instruction n+1 is completed. Once execution of the interrupt service routine is completed, the MPU resumes the running of the application program from the instruction n+2.

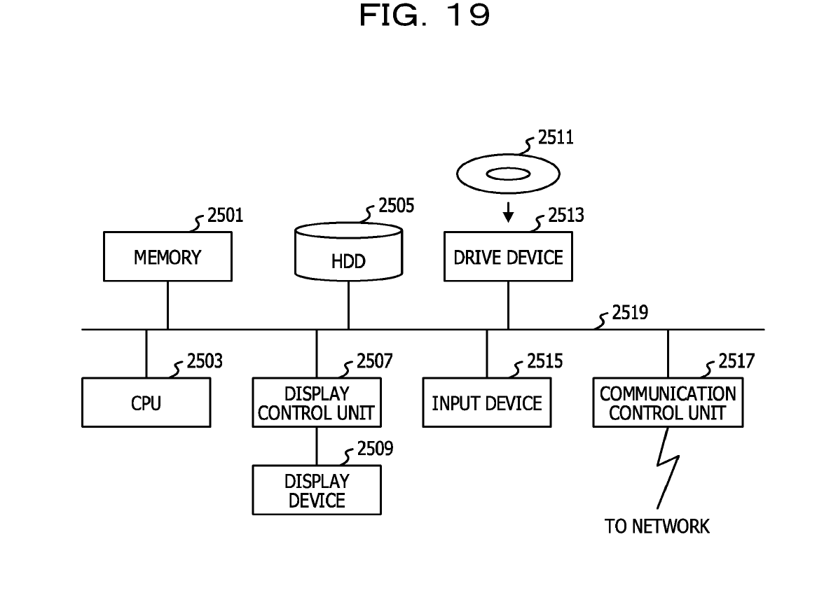

Note that the IaaS management server 1, the user terminal 10, and the IaaS administrator terminal 9 described above are computer devices, in each of which, as illustrated in FIG. 19, a memory 2501, a central processing unit (CPU) 2503, a hard disk drive (HDD) 2505, a display control unit 2507 coupled to a display device 2509, a drive device 2513 for a removable disk 2511, an input device 2515, and a communication control unit 2517 for coupling to a network are coupled by a bus 2519. An operating system (OS) and application programs for executing processes in the present embodiments are stored in the HDD 2505 and, when executed by the CPU 2503, are read from the HDD 2505 to the memory 2501. The CPU 2503 controls the display control unit 2507, the communication control unit 2517, and the drive device 2513 in accordance with the processing details of application programs to cause them to perform predetermined operations. Additionally, data being processed is primarily stored in the memory 2501 but may be stored in the HDD 2505. In the embodiments of the present disclosure, application programs for executing the processes described above are distributed in such a manner as to be stored in the computer-readable removable disk 2511 and are installed in the HDD 2505 from the drive device 2513. The application programs are sometimes installed in the HDD 2505 via a network such as the Internet and the communication control unit 2517. Such a computer device realizes various kinds of functions as described above when hardware such as the CPU 2503 and the memory 2501 and programs such as the OS and the application programs described above organically collaborate with each other.

The embodiments of the present disclosure described above are summarized as follows.

An information processing system according to a first aspect of the present embodiments includes (A) an information processing device coupled to a terminal device, and (B) a monitor device coupled to the information processing device. The information processing device mentioned above includes (a1) a processor that processes a request from the terminal device and (a2) a computing unit that computes the frequency of interrupts received by the processor. The monitor device mentioned above includes (b1) an obtaining unit that obtains, from the information processing device, information on the frequency of interrupts computed by the computing unit, (b2) a determination unit that determines, based on the information on the frequency of interrupts obtained by the obtaining unit, whether or not the frequency of interrupts exceeds a threshold in a particular period, and (b3) a data storage unit that stores a result of the determination made by the determination unit.

If the frequency of interrupts received by the processor increases, the period of time allotted to processing of a request decreases, and thus a processing delay is considered to occur. Accordingly, with the system as described above, the performance in response to requests from a terminal device may be monitored.

Additionally, the determination unit mentioned above may (b21) count the number of times the frequency of interrupts exceeds the threshold in the particular period and determine whether or not the number of times the frequency of interrupts exceeds the threshold is smaller than or equal to a first given number. It has been verified that, when a phenomenon in which a threshold is instantaneously exceeded occurs, degradation in response performance is likely to occur. Accordingly, with the system as described above, the degradation in response performance may be appropriately detected.

Additionally, the obtaining unit mentioned above may (a11) further obtain, from the information processing device, information on the computation time point, which is a time point at which the frequency of interrupts is computed, and the determination unit described above may (b22) identify, in the particular period, a computation time point at which the frequency of interrupts exceeds the threshold and determine whether or not the frequency of interrupts exceeds the threshold at the first given number or less of successive computation time points. It has been verified that there are some cases where performance degradation does not occur even if the frequency of interrupts continuously exceeds the threshold. Accordingly, with the system as described above, degradation in response performance may be appropriately detected.

Additionally, the determination unit described above may (b23) change the threshold from a first value, which is the current value of that threshold, to a second value, which is a value larger than the first value, when the frequency of interrupts exceeds the threshold at a second given number or more of successive computation time points, or when the frequency of interrupts exceeds the threshold for a first given period of time or more. When the frequency of interrupts continuously exceeds the threshold, it has been verified that, if the frequency of interrupts further increases, degradation in response performance further occurs. Accordingly, with the system as described above, oversight of performance degradation may be reduced.

Additionally, the determination unit described above may (b24) change the threshold from the second value to the first value, when the frequency of interrupts is less than the threshold at a third given number or more of successive computation time points, or when the frequency of interrupts is less than the threshold for a second given period of time or more. In this way, the threshold returns to the original value, and thus oversight of performance degradation may be reduced.

Additionally, an interrupt received by the processor may be an external interrupt. Thus, internal interrupts may be excluded from interrupts to be counted for frequency computation. This makes it possible to compute the frequency appropriately.

A performance monitor method according a second aspect of the present embodiments includes (C) receiving, from an information processing device, information on the frequency of interrupts received by a processor of the information processing device, (D) based on the received information on the frequency of interrupts, determining whether or not, in a particular period, the frequency of interrupts exceeds a threshold, and (E) storing a result of the determination in a data storage unit.

Note that a program for causing a computer to execute a process according to the above method may be created, and that program is stored in a computer-readable storage medium, for example, such as a flexible disk, a compact disk read-only memory (CD-ROM), an optical magnetic disk, a semiconductor memory, or a hard disk, or a storage device. Note also that intermediate processing results are temporarily held in a storage device such as main memory.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing system comprising:
an information processing device coupled to a terminal device; and
a monitor device coupled to the information processing device,
wherein the information processing device includes
a first processor configured to
process a request from the terminal device, and
calculate a frequency of interrupts received by the first processor, and
wherein the monitor device includes
a memory, and
a second processor configured to
obtain, from the information processing device, information on the calculated frequency of interrupts, and
determine whether or not the frequency of interrupts exceeds a threshold in a particular period based on the obtained information on the frequency of interrupts, and
store a result of the determination in the memory.

2. The information processing system according to claim 1, wherein the second processor is configured to
count a number of times the frequency of interrupts exceeds the threshold in the particular period, and
determine whether or not the number of times the frequency of interrupts exceeds the threshold is smaller than or equal to a first number.

3. The information processing system according to claim 1, wherein the second processor is further configured to
obtain information on a computation time point from the information processing device, the computation time point being a time point at which the frequency of interrupts is calculated,
identify, in the particular period, a computation time point at which the frequency of interrupts exceeds the threshold, and
determine whether or not the frequency of interrupts exceeds the threshold at the first number or less of successive computation time points.

4. The information processing system according to claim 3, wherein the second processor is configured to
when the frequency of interrupts exceeds the threshold at a second number or more of successive computation time points or when the frequency of interrupts exceeds the threshold for a first period of time or more, change the threshold from a first value being a current value of the threshold to a second value being a value larger than the first value.

5. The information processing system according to claim 4, wherein the second processor is configured to
when the frequency of interrupts is less than the frequency at a third number or more of successive computation time points or when the frequency of interrupts is less than the threshold for a second period of time or more, change the threshold from the second value to the first value.

6. The information processing system according to claim 1, wherein the interrupts received by the first processor are external interrupts.

7. A monitoring method comprising:
receiving, by a first processor, from an information processing device which includes a second processor, information on a frequency of interrupts received by the second processor;
determining, by the first processor, whether or not the frequency of interrupts exceeds a threshold in a particular period based on the received information on the frequency of interrupts; and
store a result of the determination in a memory.

8. The monitoring method according to claim 7, further comprising:
counting, by the first processor, a number of times the frequency of interrupts exceeds the threshold in the particular period; and
determining whether or not the number of times the frequency of interrupts exceeds the threshold is smaller than or equal to a first number.

9. The monitoring method according to claim 7, further comprising:
obtaining, by the first processor, information on a computation time point from the information processing device, the computation time point being a time point at which the frequency of interrupts is calculated,
identifying, by the first processor in the particular period, a computation time point at which the frequency of interrupts exceeds the threshold, and
determining, by the first processor, whether or not the frequency of interrupts exceeds the threshold at the first number or less of successive computation time points.

10. The monitoring method according to claim 9, further comprising:
changing, when the frequency of interrupts exceeds the threshold at a second number or more of successive computation time points or when the frequency of interrupts exceeds the threshold for a first period of time or more, the threshold from a first value being a current value of the threshold to a second value being a value larger than the first value.

11. The monitoring method according to claim 10, further comprising:
changing, when the frequency of interrupts is less than the frequency at a third number or more of successive computation time points or when the frequency of interrupts is less than the threshold for a second period of time or more, the threshold from the second value to the first value.

12. The monitoring method according to claim 7, wherein
the interrupts received by the second processor are external interrupts.

13. A non-transitory computer readable recording medium having stored therein a program that causes a computer to execute a process, the process comprising:
receiving from an information processing device which includes a processor, information on a frequency of interrupts received by the processor;
determining whether or not the frequency of interrupts exceeds a threshold in a particular period based on the received information on the frequency of interrupts; and
store a result of the determination in a memory.

14. The non-transitory computer readable recording medium according to claim 13, wherein the process further comprising:
counting a number of times the frequency of interrupts exceeds the threshold in the particular period; and
determining whether or not the number of times the frequency of interrupts exceeds the threshold is smaller than or equal to a first number.

15. The non-transitory computer readable recording medium according to claim 13, wherein the process further comprising:
obtaining information on a computation time point from the information processing device, the computation time point being a time point at which the frequency of interrupts is calculated,
identifying, in the particular period, a computation time point at which the frequency of interrupts exceeds the threshold, and
determining whether or not the frequency of interrupts exceeds the threshold at the first number or less of successive computation time points.

16. The non-transitory computer readable recording medium according to claim 15, wherein the process further comprising:
changing, when the frequency of interrupts exceeds the threshold at a second number or more of successive computation time points or when the frequency of interrupts exceeds the threshold for a first period of time or more, the threshold from a first value being a current value of the threshold to a second value being a value larger than the first value.

17. The non-transitory computer readable recording medium according to claim 16, wherein the process further comprising:
changing, when the frequency of interrupts is less than the frequency at a third number or more of successive computation time points or when the frequency of interrupts is less than the threshold for a second period of time or more, the threshold from the second value to the first value.

18. The non-transitory computer readable recording medium according to claim 13, wherein
the interrupts received by the processor are external interrupts.
